(19) United States
(12) Patent Application Publication
(10) Pub. No.: US 2026/0200129 A1
(43) Pub. Date: Jul. 16, 2026

(54) 3D PRINTING-BASED 3D RE-ENTRANT NEGATIVE POISSON'S RATIO PREFABRICATED COMPOSITE PROTECTIVE STRUCTURE AND PREPARATION METHOD THEREOF

(71) Applicants: School of Civil Engineering and Architecture, Zhejiang University of Science and Technology, Hangzhou (CN); College of Civil Engineering, Zhejiang University of Technology, Hangzhou (CN); Zhejiang Jiushu New Material Technology Development Co., Ltd, Huzhou (CN); Shandong Transportation Institute, Jinan (CN)

(72) Inventors: Xin Zhao, Hangzhou (CN); Jintao Liu, Hangzhou (CN); Runkai Zhou, Huzhou (CN); Hui Jin, Hangzhou (CN); Baolin Guo, Jinan (CN); Ruishuang Jiang, Jinan (CN)

(21) Appl. No.: 19/448,165

(22) Filed: Jan. 14, 2026

(30) Foreign Application Priority Data
Jan. 15, 2025 (CN) 202510063188.2

(51) Int. Cl. B28B 1/50; B28B 7/00

(52) U.S. Cl. CPC B28B 1/503; B28B 2007/005

(57) ABSTRACT

A three-dimensional (3D) printing-based 3D re-entrant negative Poisson's ratio prefabricated composite protective structure is provided, which includes multiple 3D double-branch re-entrant hexagonal unit cells, steel screws, and a lightweight foam material. Each of the multiple 3D double-branch re-entrant hexagonal unit cells is formed by rotating one of two double-branch re-entrant hexagonal units 90 degrees along a long axis direction thereof and then arranging the double-branch re-entrant hexagonal units orthogonally. Holes are defined at middle positions of vertical side branch inclined ribs of the 3D double-branch re-entrant hexagonal unit cell, the holes are configured for the steel screws to pass therethrough to fix the 3D double-branch re-entrant hexagonal unit cell with the other 3D double-branch re-entrant hexagonal unit cells adjacent to the 3D double-branch re-entrant hexagonal unit cell, and the lightweight foam material is uniformly dispersed within the multiple 3D double-branch re-entrant hexagonal unit cells.

### CROSS-REFERENCE TO RELATED APPLICATION

The present disclosure claims the priority of Chinese Patent Application No. 202510063188.2, filed on Jan. 15, 2025, which is herein incorporated by reference in its entirety.

### TECHNICAL FIELD

The present disclosure relates to the technical field of construction engineering, in particular to a three-dimensional (3D) printing-based 3D re-entrant negative Poisson's ratio prefabricated composite protective structure and a preparation method thereof.

### BACKGROUND

Modern engineering continuously presents new requirements and challenges for structures and materials. A negative Poisson's ratio structure, i.e., a structure with a negative Poisson's ratio possesses many characteristics and advantages not found in other traditional structures, such as a stronger shear resistance, a higher fracture toughness, and a larger energy absorption capacity. Precisely because of these unique advantages, the negative Poisson's ratio structure has unique functions like anti-explosion and penetration resistance, impact resistance, shock absorption, deformation resistance, and enhancement of basic mechanical properties. These functions have wide applications in fields such as ships, aerospace, and explosion protection. Currently, in a construction industry, application scenarios for the negative Poisson's ratio structure for impact resistance mainly involve structural optimization using steel as a raw material, with very few designs targeting concrete materials. Traditional re-entrant structures experience stress concentration at corner points between unit cell walls during loading, leading to failure, while other parts bear less stress.

### SUMMARY

To overcome deficiencies of the related art, the present disclosure provides a 3D printing-based 3D re-entrant negative Poisson's ratio prefabricated composite protective structure and a preparation method thereof, which significantly enhances a stiffness of the structure at outer inclined ribs, greatly improves a stiffness in a vertical direction, avoids premature local failure of the structure, thereby achieving better impact resistance and deformation capability for the structure.

Technical solutions adopted by the present disclosure to solve the above technical problem are as follows.

In an embodiment, a 3D printing-based 3D re-entrant negative Poisson's ratio prefabricated composite protective structure is provided, which includes: multiple 3D double-branch re-entrant hexagonal unit cells, steel screws, and a lightweight foam material. Each of the multiple 3D double-branch re-entrant hexagonal unit cells is formed by rotating one of two double-branch re-entrant hexagonal units 90 degrees along a long axis direction thereof and then arranging the double-branch re-entrant hexagonal units orthogonally. Basic geometric parameters of the 3D double-branch re-entrant hexagonal unit cell include: a horizontal side length h, a unit outer cell wall length l₁, a unit inner cell wall length l₂, an angle θ₁ between an outer inclined wall of the 3D double-branch re-entrant hexagonal unit cell and a vertical line, an angle θ₂ between an inner inclined wall of the 3D double-branch re-entrant hexagonal unit cell and the vertical line, a wall thickness t of the 3D double-branch re-entrant hexagonal unit cell, a height y of the 3D double-branch re-entrant hexagonal unit cell, and a length x of the 3D double-branch re-entrant hexagonal unit cell. The height y of the 3D double-branch re-entrant hexagonal unit cell, and the length x of the 3D double-branch re-entrant hexagonal unit cell are calculated according to the following formulas: x=2(h−l₂ sin θ₂), and y=2l₁ cos θ₁. Holes are defined at middle positions of vertical side branch inclined ribs of the 3D double-branch re-entrant hexagonal unit cell, the holes are configured for the steel screws to pass therethrough to fix the 3D double-branch re-entrant hexagonal unit cell with the other 3D double-branch re-entrant hexagonal unit cells adjacent to the 3D double-branch re-entrant hexagonal unit cell, and the lightweight foam material is uniformly dispersed within the multiple 3D double-branch re-entrant hexagonal unit cells.

In an embodiment, in the 3D double-branch re-entrant hexagonal unit cell, the angle θ₁ between the outer inclined wall of the 3D double-branch re-entrant hexagonal unit cell and the vertical line is 16 degrees, the angle θ₂ between the inner inclined wall of the 3D double-branch re-entrant hexagonal unit cell and the vertical line is 30 degrees, the wall thickness t of the 3D double-branch re-entrant hexagonal unit cell is in a range of 10 mm to 30 mm, and the horizontal side length h is in a range of 100 mm to 200 mm.

In an embodiment, in the 3D double-branch re-entrant hexagonal unit cell, the holes with a diameter in a range of 5 mm to 10 mm are defined at the middle positions of the vertical side branch inclined ribs with a total number of 8, and are configured for the steel screws to pass therethrough to fix the 3D double-branch re-entrant hexagonal unit cell with the other 3D double-branch re-entrant hexagonal unit cells adjacent to the 3D double-branch re-entrant hexagonal unit cell.

In an embodiment, the 3D double-branch re-entrant hexagonal unit cell is prepared by preforming 3D printing and using a fiber-reinforced concrete material, and the 3D double-branch re-entrant hexagonal unit cell has a compressive strength reaching over 100 MPa and an ultimate tensile strain reaching over 5%.

In an embodiment, raw materials of the lightweight foam material are rapid-hardening Portland cement, 40-200 mesh quartz powder, hydrogen peroxide with a purity of 30%, calcium stearate with a calcium content of 7.0%, polycarboxylate superplasticizer, and water. Weight ratios of the raw materials are as follows: the rapid-hardening Portland cement: 150-200 parts, the 40-200 mesh quartz powder: 100-130 parts, the hydrogen peroxide with the purity of 30%: 10-13 parts, the calcium stearate with the calcium content of 7.0%: 5-7 parts, the polycarboxylate superplasticizer: 1.0-1.3 parts, and the water: 125-165 parts.

In an embodiment, the lightweight foam material has a compressive strength reaching over 5 MPa, a density of 200-400 kg/m³, and a setting time of 10-15 minutes.

In an embodiment, a preparation method is provided, which is used to prepare the 3D printing-based 3D re-entrant negative Poisson's ratio prefabricated composite protective structure described above, and the preparation method includes the following steps:
S1: mutually splicing any two pre-printed 3D negative Poisson's ratio structure basic units, aligning defined holes in middle positions of vertical side branch inclined ribs of the two pre-printed 3D negative Poisson's ratio structure basic units, then passing fastening screws through the defined holes and tightening the two pre-printed 3D negative Poisson's ratio structure basic units through connecting nuts to the fastening screws;
S2: according to size requirements of the 3D printing-based 3D re-entrant negative Poisson's ratio prefabricated composite protective structure, sequentially arranging multiple 3D negative Poisson's ratio structure basic units through spatial expansion to form a 3D negative Poisson's ratio protective structure body; and
S3: disposing a formwork outside the 3D negative Poisson's ratio protective structure body, where the formwork is configured for supporting the 3D negative Poisson's ratio protective structure body; pouring mixed cement-based lightweight foam slurry into an interior of the 3D negative Poisson's ratio protective structure body, removing the formwork after the mixed cement-based lightweight foam slurry sets and hardens to finally obtain the 3D printing-based 3D re-entrant negative Poisson's ratio prefabricated composite protective structure, and curing the 3D printing-based 3D re-entrant negative Poisson's ratio prefabricated composite protective structure to a specified age.

A technical concept of the present disclosure is as follows. The present disclosure improves the traditional re-entrant structure by adopting a manner of adding supporting arms to obtain a 3D double-branch re-entrant hexagonal unit cell, which is also referred to as a double Re-entrant Honeycomb (DRH). As shown in the FIGURE, six basic geometric parameters, i.e., h, l₁, l₂, θ₁, θ₂, and t, determine specific dimensions of the basic DRH unit cell. Here, h represents a horizontal side length, l₁ represents a unit outer cell wall length, l₂ represents a unit inner cell wall length, θ₁ represents an angle between an outer inclined wall of the 3D double-branch re-entrant hexagonal unit cell and a vertical line, θ₂ represents an angle between an inner inclined wall of the 3D double-branch re-entrant hexagonal unit cell and the vertical line, and t represents a wall thickness of the 3D double-branch re-entrant hexagonal unit cell. Two other basic geometric parameters are a height y of the 3D double-branch re-entrant hexagonal unit cell and a length x of the 3D double-branch re-entrant hexagonal unit cell, which can be derived from the other parameters according to the following formulas:

$$x = 2 ( h - {l}_{2} sin {θ}_{2} )$$

$$y = 2 {l}_{1} cos {θ}_{1} .$$

The novel 3D double re-entrant structure in the present disclosure differs from a traditional structure. Considering stress characteristics of the high strength and high ductility concrete (HSHDC), a stiffness of each of outer inclined ribs is increased through theoretical and experimental calculations. On one hand, this makes an elastic modulus of the unit cell more than three times higher than that of traditional re-entrant structure, greatly improving a stiffness in a vertical direction. On the other hand, local reinforcement of the side inclined ribs changes a stress distribution state during loading, preventing an overall structure of the unit cell from experiencing premature local failure. The absolute value of the negative Poisson's ratio of the novel 3D double re-entrant structure of the present disclosure is also much higher than that of traditional re-entrant structure.

Beneficial effects of the present disclosure are mainly as follows.
1. The present disclosure significantly enhances the stiffness of the structure at the outer inclined ribs, greatly improves the stiffness in the vertical direction, avoids premature local failure of the overall structure, thereby achieving better impact resistance and deformation capability.
2. The present disclosure innovatively designs the form and angles of the novel double re-entrant structure unit via 3D printing, designs the fiber structural units and their stacked array distribution within the lightweight foam material, and combines them to obtain a precast concrete structural template with a special morphology. It utilizes high-strength bolt connections to prepare a prefabricated composite protective structure possessing a negative Poisson's ratio effect.
3. The present disclosure adopts a 3D printing method to create the double re-entrant structure. The novel 3D double re-entrant structure, using 3D printing, can improve the efficiency of fabricating the structure, greatly saving time for making protective structures. The processing is simple and easy to realize.
4. The middle part of the double re-entrant structure achieves closure, which greatly increases the stiffness of the structure in the vertical direction, preventing local failure of the overall structure, especially at the corners of the 3D model, which are prone to failure. This structure can effectively improve impact and deformation resistance.
5. The lightweight foam material can well integrate with the cement-based composite material described in the present disclosure. Through crystal microstructure design, the Poisson's ratio value is greatly reduced, endowing it with a negative Poisson's ratio effect, thereby significantly enhancing the energy absorption modulus, energy dissipation modulus, and energy storage modulus.

### BRIEF DESCRIPTION OF DRAWINGS

FIG. 1 illustrates a two-dimensional schematic illustration of a double re-entrant cell body according to an embodiment of the present disclosure.

FIG. 2 illustrates a process for generating multiple 3D double-branch re-entrant hexagonal unit cells, in which a of FIG. 2 shows a single double-branch re-entrant hexagonal unit; b of FIG. 2 shows two such double-branch re-entrant hexagonal units arranged orthogonally, to thereby form a single unit cell; and c of FIG. 2 shows the resulting 3D structure formed by interconnecting multiple unit cells.

FIG. 3 illustrates a partial schematic plan view of a 3D printing-based 3D re-entrant negative Poisson's ratio prefabricated composite protective structure according to an embodiment of the present disclosure.

### DETAILED DESCRIPTION OF EMBODIMENTS

The present disclosure is further described below in conjunction with the accompanying drawing.

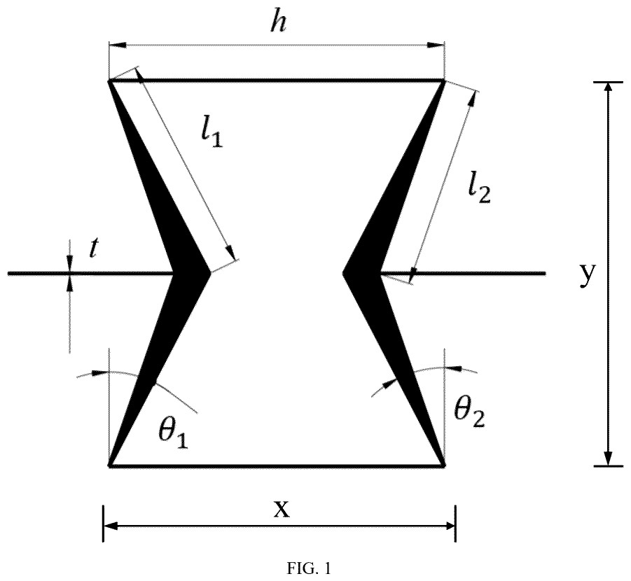

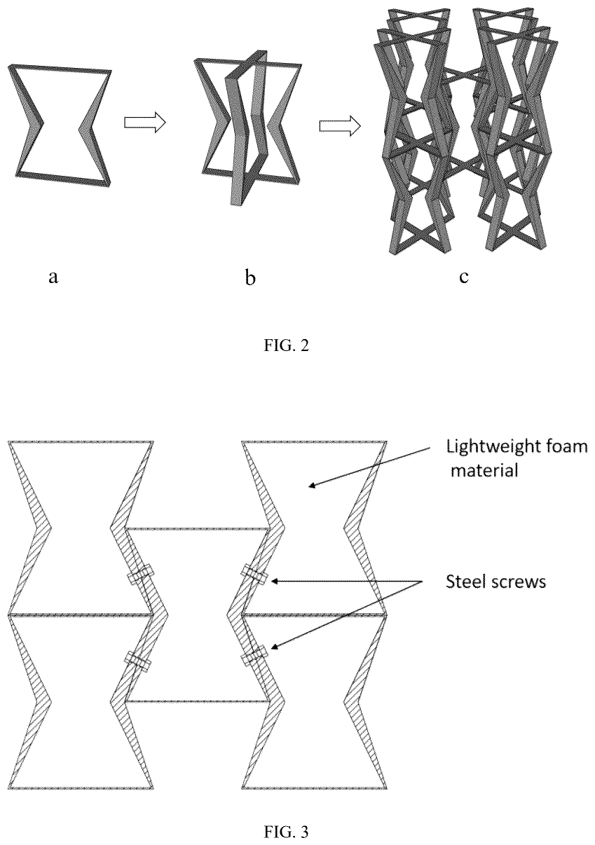

Referring to FIGS. 1 through 3, a 3D printing-based 3D re-entrant negative Poisson's ratio prefabricated composite protective structure is provided, which includes: multiple 3D double-branch re-entrant hexagonal unit cells, steel screws, and a lightweight foam material. Each of the multiple 3D double-branch re-entrant hexagonal unit cells is formed by rotating one of two double-branch re-entrant hexagonal units 90 degrees along a long axis direction thereof and then arranging the two double-branch re-entrant hexagonal units orthogonally in space. Basic geometric parameters of the 3D double-branch re-entrant hexagonal unit cell include a horizontal side length h, a unit outer cell wall length l₁, a unit inner cell wall length l₂, an angle θ₁ between an outer inclined wall of the 3D double-branch re-entrant hexagonal unit cell and a vertical line, an angle θ₂ between an inner inclined wall of the 3D double-branch re-entrant hexagonal unit cell and the vertical line, a wall thickness t of the 3D double-branch re-entrant hexagonal unit cell, a height y of the 3D double-branch re-entrant hexagonal unit cell, and a length x of the 3D double-branch re-entrant hexagonal unit cell. The height y of the 3D double-branch re-entrant hexagonal unit cell and the length x of the 3D double-branch re-entrant hexagonal unit cell are calculated according to the following formulas:

$$x = 2 ( h - {l}_{2} sin {θ}_{2} )$$

$$y = 2 {l}_{1} cos {θ}_{1} .$$

Holes are defined at middle positions of vertical side branch inclined ribs of the 3D double-branch re-entrant hexagonal unit cell, and the holes are used for steel screws to pass therethrough to fix the 3D double-branch re-entrant hexagonal unit cell with the other 3D double-branch re-entrant hexagonal unit cells adjacent to the 3D double-branch re-entrant hexagonal unit cell. The lightweight foam material is uniformly dispersed within the multiple 3D double-branch re-entrant hexagonal unit cells.

Further, in the 3D double-branch re-entrant hexagonal unit cell, the angle θ₁ between the outer inclined wall of the 3D double-branch re-entrant hexagonal unit cell and the vertical line is 16 degrees, the angle θ₂ between the inner inclined wall of the 3D double-branch re-entrant hexagonal unit cell and the vertical line is 30 degrees, the wall thickness t of the 3D double-branch re-entrant hexagonal unit cell is in a range of 10 mm to 30 mm, and the horizontal side length h is in a range of 100 mm to 200 mm.

A total number of the vertical side branch inclined ribs of the 3D double-branch re-entrant hexagonal unit cell is 8, and a diameter of each of the holes defined at the middle positions of the 8 vertical side branch inclined ribs of the 3D double-branch re-entrant hexagonal unit cell is in a range of 5 mm to 10 mm. The holes are configured for the steel screws to pass therethrough to fix the 3D double-branch re-entrant hexagonal unit cell with the other 3D double-branch re-entrant hexagonal unit cells adjacent to the 3D double-branch re-entrant hexagonal unit cell.

The 3D double-branch re-entrant hexagonal unit cell is prepared by preforming 3D printing and using a high-strength and high-toughness fiber-reinforced concrete material. The 3D double-branch re-entrant hexagonal unit cell has a compressive strength reaching over 100 MPa and an ultimate tensile strain reaching over 5%.

Raw materials of the lightweight foam material are rapid-hardening Portland cement, 40-200 mesh quartz powder, hydrogen peroxide with a purity of 30%, calcium stearate with a calcium content of 7.0%, polycarboxylate superplasticizer, and water. Weight ratios of the raw materials are as follows: the rapid-hardening Portland cement: 150-200 parts, the 40-200 mesh quartz powder: 100-130 parts, the hydrogen peroxide with the purity of 30%: 10-13 parts, the calcium stearate with the calcium content of 7.0%: 5-7 parts, the polycarboxylate superplasticizer: 1.0-1.3 parts, and the water: 125-165 parts.

The lightweight foam material has a compressive strength reaching over 5 MPa, a density of 200-400 kg/m³, and a setting time of 10-15 minutes.

A preparation method of the 3D printing-based 3D re-entrant negative Poisson's ratio prefabricated composite protective structure is provided, which includes the following steps:
S1: mutually splicing any two pre-printed 3D negative Poisson's ratio structure basic units (i.e., 3D double-branch re-entrant hexagonal unit cells), aligning defined holes in the middle positions of the vertical side branch inclined ribs of the two pre-printed 3D negative Poisson's ratio structure basic units, then passing fastening screws through the defined holes and tightening the two pre-printed 3D negative Poisson's ratio structure basic units through connecting nuts to the fastening screws;
S2: according to size requirements of the 3D printing-based 3D re-entrant negative Poisson's ratio prefabricated composite protective structure, sequentially arranging multiple 3D negative Poisson's ratio structure basic units through spatial expansion to form a 3D negative Poisson's ratio protective structure body; and
S3: disposing a formwork outside the 3D negative Poisson's ratio protective structure body, pouring mixed cement-based lightweight foam slurry into an interior of the 3D negative Poisson's ratio protective structure body, removing the formwork after the mixed cement-based lightweight foam slurry sets and hardens to finally obtain the 3D printing-based 3D re-entrant negative Poisson's ratio prefabricated composite protective structure, and curing the 3D printing-based 3D re-entrant negative Poisson's ratio prefabricated composite protective structure to a specified age.

### Embodiment 1

3D printed structural units with Poisson's ratio effect, i.e., 3D double-branch re-entrant hexagonal unit cells are obtained. Each 3D double-branch re-entrant hexagonal unit cell is formed by rotating one of two double-branch re-entrant hexagonal units 90 degrees along a long axis direction thereof and then arranging the double-branch re-entrant hexagonal units orthogonally in space, and is a three-layer layered structure.

Lightweight concrete with a Poisson's ratio effect is used to prepare the 3D double-branch re-entrant hexagonal unit cell. Holes with a diameter of 5 mm to 10 mm are defined at middle positions of 8 vertical side branch inclined ribs of the 3D double-branch re-entrant hexagonal unit cell, and is used for steel screws to pass therethrough and to fix the 3D double-branch re-entrant hexagonal unit cell with other 3D double-branch re-entrant hexagonal unit cells adjacent to the 3D double-branch re-entrant hexagonal unit cell. The multiple 3D double-branch re-entrant hexagonal unit cells forming the 3D printing-based 3D re-entrant negative Poisson's ratio prefabricated composite protective structure are arranged in a directional, ordered, dense array.

A preparation method of the 3D printing-based 3D re-entrant negative Poisson's ratio prefabricated composite protective structure is provided, and the preparation method includes the following steps:
(1) preparation: according to a requirement of the 3D double-branch re-entrant hexagonal unit cells, printing the 3D double-branch re-entrant hexagonal unit cells by using a 3D printer, where holes with a diameter of 5 mm to 10 mm are defined at middle positions of 8 vertical side branch inclined ribs of each 3D double-branch re-entrant hexagonal unit cell and is used for steel screws to pass therethrough to fix other 3D double-branch re-entrant hexagonal unit cells adjacent to the 3D double-branch re-entrant hexagonal unit cel; and each 3D double-branch re-entrant hexagonal unit cell is polished to thereby obtain a prefabricated reinforced structural template;
(2) coating a release agent: coating the release agent on a surface of the prefabricated reinforced structural template to increase interface adhesion and deformation coordination, where a primer of the release agent is an epoxy resin primer; and
(3) pouring: mixing lightweight concrete according to a concrete mix design and then pouring into a 3D printed 3D re-entrant negative Poisson's ratio structural template, i.e., the prefabricated reinforced structural template, performing static maintenance, to thereby obtain the 3D printing-based 3D re-entrant negative Poisson's ratio prefabricated composite protective structure with negative Poisson's ratio properties.

A comparative test is performed, in which a 3D printed ordinary structure (square) is obtained, with other conditions being the same as the 3D printing-based 3D re-entrant negative Poisson's ratio prefabricated composite protective structure.

To obtain a Poisson's ratio of the 3D printing-based 3D re-entrant negative Poisson's ratio prefabricated composite protective structure prepared according to the above method, the following method is used to test specimens in the present disclosure.

A testing method is performed.

Specimens are prepared. Embodiment specimens of 3D printing-based 3D re-entrant negative Poisson's ratio prefabricated composite protective structures with dimensions of 400 mm×400 mm×400 mm and 400 mm×400 mm×1600 mm are prepared using the method described in the Embodiment 1. Simultaneously, control group specimens of the same dimensions are prepared, and the control group specimens are ordinary cast concrete cube structures. Specifically, the embodiment specimens and the control group specimens with dimensions of 400 mm×400 mm×400 mm are used for modulus testing and strength testing, while the embodiment specimens and the control group specimens with dimensions of 400 mm×400 mm×1600 mm are used for Poisson's ratio testing.

A specific method for strength testing includes: according to the national standard “Standard for Test Methods of Mechanical Properties of Ordinary Concrete”, i.e., GB/T50081-2016, using a mechanical testing machine to measure compressive strengths and flexural strengths of the embodiment specimens and the control group specimens with dimensions of 400 mm×400 mm×400 mm, and measuring each of specimens three times and taking an average to obtain a corresponding final strength result.

A specific method for Poisson's ratio testing includes: using the mechanical testing machine to apply load until 60% of a maximum strength of each of the embodiment specimens and the control group specimens with dimensions of 400 mm×400 mm×1600 mm is reached, then stop loading, measuring a lateral strain (εx) and a longitudinal strain (εy) of a paste specimen, and calculating a corresponding Poisson's ratio value according to a formula v=−εx/εy. Through calculating, a Poisson's ratio value of an ordinary cement-based material (i.e., the cement specimen in the control group) is 0.25, and a Poisson's ratio value of the re-entrant hexagonal negative Poisson's ratio structure of the present disclosure is −0.5. A volume ratio of the negative Poisson's ratio structure (i.e., the re-entrant hexagonal negative Poisson's ratio structure) within the paste specimen can be calculated.

A specific method for energy absorption modulus testing includes: using the mechanical testing machine to perform a compression test on each of the embodiment specimens and the control group specimens with dimensions of 400 mm×400 mm×400 mm along an axial direction to obtain a corresponding stress-strain (6-8) curve of each specimen. A maximum stress Om is determined, and an energy absorption modulus of a corresponding material is determined according to a formula

$$E = {\int }_{θ}^{{σ}_{max}} σ ( ε ) d ε / {σ}_{m} ,$$

where σ(ε) represents a stress, and σₘₐₓ represents a peak stress.

### Embodiment 2

The 3D printing-based 3D re-entrant negative Poisson's ratio prefabricated protective structure includes negative Poisson's ratio structures uniformly dispersed in the 3D printing-based 3D re-entrant negative Poisson's ratio prefabricated protective structure. Each negative Poisson's ratio structure is a layered structure formed by ordered arrangement of re-entrant hexagonal unit cells. Each re-entrant hexagonal unit cell includes two opposite vertices, which are recessed inward towards an interior of the hexagon, with two parallel long sides set on two sides of one of the two opposite vertices. The ordered arrangement specifically means that multiple re-entrant hexagonal unit cells are connected end to end, with long sides thereof overlapping in pairs to form rows, and re-entrant hexagonal unit cells in adjacent rows are staggered and connected by overlapping side edges of corresponding vertices, thus obtaining a layered structure. A volume ratio of each of negative Poisson's ratio structures in the 3D printing-based 3D re-entrant negative Poisson's ratio prefabricated protective structure is 40%.

A preparation method of the 3D printing-based 3D re-entrant negative Poisson's ratio prefabricated composite protective structure is provided, and the preparation method includes the following steps:
(1) preparation: according to a requirement of the 3D double-branch re-entrant hexagonal unit cells, printing the 3D double-branch re-entrant hexagonal unit cells by using a 3D printer, where holes with a diameter of 5 mm to 10 mm are defined at middle positions of 8 vertical side branch inclined ribs of each 3D double-branch re-entrant hexagonal unit cell and is used for steel screws to pass therethrough to fix other 3D double-branch re-entrant hexagonal unit cells adjacent to the 3D double-branch re-entrant hexagonal unit cel; and each 3D double-branch re-entrant hexagonal unit cell is polished to thereby obtain a prefabricated reinforced structural template;
(2) coating a release agent: coating the release agent on a surface of the prefabricated reinforced structural template to increase interface adhesion and deformation coordination, where a primer of the release agent is an epoxy resin primer; and
(3) pouring: mixing lightweight concrete according to a concrete mix design and then pouring into a 3D printed 3D re-entrant negative Poisson's ratio structural template, i.e., the prefabricated reinforced structural template, performing static maintenance, to thereby obtain the 3D printing-based 3D re-entrant negative Poisson's ratio prefabricated composite protective structure with negative Poisson's ratio properties.

A comparative test is performed, in which a 3D printed ordinary structure (square) is obtained, with other conditions being the same as the 3D printing-based 3D re-entrant negative Poisson's ratio prefabricated composite protective structure.

The lightweight composite material consists of rapid-hardening Portland cement, mesh quartz powder, hydrogen peroxide with a purity of 30%, calcium stearate with a calcium content of 7.0%, polycarboxylate superplasticizer, and water. Weight ratios of the above components are as follows: the rapid-hardening Portland cement: 190 parts, the mesh quartz powder: 125 parts, the hydrogen peroxide with the purity of 30%: 13 parts, the calcium stearate with the calcium content of 7.0%: 7 parts, the polycarboxylate superplasticizer: 1.3 parts, and the water: 155 parts.

A preparation method for the lightweight composite material includes the following steps: (1) placing the rapid-hardening Portland cement into a mixing device, performing lower speed stirring for about 1 minute to mix evenly; then slowly adding an appropriate amount of water, and performing low-speed stirring for 30 seconds to disperse the rapid-hardening Portland cement evenly in the water; (2) adding the polycarboxylate superplasticizer to the mixing device, performing lower speed stirring for 30 seconds; and (3) performing high-speed stirring for 35 seconds, and while stirring, adding the calcium stearate with the calcium content of 7.0% and the mesh quartz powder, then performing low-speed stirring for 10 seconds to obtain a mixture, then quickly placing the mixture into a mold of the 3D printed 3D re-entrant negative Poisson's ratio prefabricated protective structure; moving the mold to a cool, dry place for curing for a period (typically 24 hours); after a specimen in the mold gains a certain strength, removing the specimen from the mold, and moving the specimen to a curing room for curing until a test age, thus obtaining the concrete. Specifically, a speed corresponding to the low-speed stirring is 50 r/min, and a speed corresponding to the high-speed stirring speed is 300 r/min.

The contents described in the embodiments of the present disclosure are merely enumerations of forms for realizing the inventive concept, for illustrative purposes only. The scope of protection of the present disclosure should not be considered as limited to the specific forms stated in the embodiments. The scope of protection of the present disclosure also extends to equivalent technical means that can be conceived by those skilled in the art based on the inventive concept.

1. A three-dimensional (3D) printing-based 3D re-entrant negative Poisson's ratio prefabricated composite protective structure, comprising: multiple 3D double-branch re-entrant hexagonal unit cells, steel screws, and a lightweight foam material;
wherein each of the multiple 3D double-branch re-entrant hexagonal unit cells is formed by rotating one of two double-branch re-entrant hexagonal units 90 degrees along a long axis direction thereof and then arranging the double-branch re-entrant hexagonal units orthogonally;
wherein basic geometric parameters of the 3D double-branch re-entrant hexagonal unit cell comprise: a horizontal side length h, a unit outer cell wall length l₁, a unit inner cell wall length l₂, an angle θ₁ between an outer inclined wall of the 3D double-branch re-entrant hexagonal unit cell and a vertical line, an angle θ₂ between an inner inclined wall of the 3D double-branch re-entrant hexagonal unit cell and the vertical line, a wall thickness t of the 3D double-branch re-entrant hexagonal unit cell, a height y of the 3D double-branch re-entrant hexagonal unit cell, and a length x of the 3D double-branch re-entrant hexagonal unit cell;
wherein the height y of the 3D double-branch re-entrant hexagonal unit cell, and the length x of the 3D double-branch re-entrant hexagonal unit cell are calculated according to the following formulas:
$$x = 2 ( h - {l}_{2} - sin {θ}_{2} )$$
$$y = 2 {l}_{1} - cos {θ}_{1} ;$$
and
wherein holes are defined at middle positions of vertical side branch inclined ribs of the 3D double-branch re-entrant hexagonal unit cell, the holes are configured for the steel screws to pass therethrough to fix the 3D double-branch re-entrant hexagonal unit cell with the other 3D double-branch re-entrant hexagonal unit cells adjacent to the 3D double-branch re-entrant hexagonal unit cell, and the lightweight foam material is uniformly dispersed within the multiple 3D double-branch re-entrant hexagonal unit cells.

2. The 3D printing-based 3D re-entrant negative Poisson's ratio prefabricated composite protective structure as claimed in claim 1, wherein in the 3D double-branch re-entrant hexagonal unit cell, the angle θ₁ between the outer inclined wall of the 3D double-branch re-entrant hexagonal unit cell and the vertical line is 16 degrees, the angle θ₂ between the inner inclined wall of the 3D double-branch re-entrant hexagonal unit cell and the vertical line is 30 degrees, the wall thickness t of the 3D double-branch re-entrant hexagonal unit cell is in a range of 10 mm to 30 mm, and the horizontal side length h is in a range of 100 mm to 200 mm.

3. The 3D printing-based 3D re-entrant negative Poisson's ratio prefabricated composite protective structure as claimed in claim 1, wherein in the 3D double-branch re-entrant hexagonal unit cell, the holes with a diameter in a range of 5 mm to 10 mm are defined at the middle positions of the vertical side branch inclined ribs with a total number of 8, and are configured for the steel screws to pass therethrough to fix the 3D double-branch re-entrant hexagonal unit cell with the other 3D double-branch re-entrant hexagonal unit cells adjacent to the 3D double-branch re-entrant hexagonal unit cell.

4. The 3D printing-based 3D re-entrant negative Poisson's ratio prefabricated composite protective structure as claimed in claim 1, wherein the 3D double-branch re-entrant hexagonal unit cell is prepared by preforming 3D printing and using a fiber-reinforced concrete material, and the 3D double-branch re-entrant hexagonal unit cell has a compressive strength reaching over 100 MPa and an ultimate tensile strain reaching over 5%.

5. The 3D printing-based 3D re-entrant negative Poisson's ratio prefabricated composite protective structure as claimed in claim 1, wherein raw materials of the lightweight foam material are rapid-hardening Portland cement, 40-200 mesh quartz powder, hydrogen peroxide with a purity of 30%, calcium stearate with a calcium content of 7.0%, polycarboxylate superplasticizer, and water; and
wherein weight ratios of the raw materials are as follows: the rapid-hardening Portland cement: 150-200 parts, the 40-200 mesh quartz powder: 100-130 parts, the hydrogen peroxide with the purity of 30%: 10-13 parts, the calcium stearate with the calcium content of 7.0%: 5-7 parts, the polycarboxylate superplasticizer: 1.0-1.3 parts, and the water: 125-165 parts.

6. The 3D printing-based 3D re-entrant negative Poisson's ratio prefabricated composite protective structure as claimed in claim 5, wherein the lightweight foam material has a compressive strength reaching over 5 MPa, a density of 200-400 kg/m³, and a setting time of 10-15 minutes.

7. A preparation method, wherein the preparation method is used to prepare the 3D printing-based 3D re-entrant negative Poisson's ratio prefabricated composite protective structure as claimed in claim 1, and comprises the following steps:
S1: mutually splicing any two pre-printed 3D negative Poisson's ratio structure basic units, aligning defined holes in middle positions of vertical side branch inclined ribs of the two pre-printed 3D negative Poisson's ratio structure basic units, then passing fastening screws through the defined holes and tightening the two pre-printed 3D negative Poisson's ratio structure basic units through connecting nuts to the fastening screws;
S2: according to size requirements of the 3D printing-based 3D re-entrant negative Poisson's ratio prefabricated composite protective structure, sequentially arranging multiple 3D negative Poisson's ratio structure basic units through spatial expansion to form a 3D negative Poisson's ratio protective structure body; and
S3: disposing a formwork outside the 3D negative Poisson's ratio protective structure body, where the formwork is configured for supporting the 3D negative Poisson's ratio protective structure body; pouring mixed cement-based lightweight foam slurry into an interior of the 3D negative Poisson's ratio protective structure body, removing the formwork after the mixed cement-based lightweight foam slurry sets and hardens to finally obtain the 3D printing-based 3D re-entrant negative Poisson's ratio prefabricated composite protective structure, and curing the 3D printing-based 3D re-entrant negative Poisson's ratio prefabricated composite protective structure to a specified age.
